(19) United States
(12) Patent Application Publication
(10) Pub. No.: US 2017/0221167 A1
(43) Pub. Date: Aug. 3, 2017

(54) System and Network for Detecting Unauthorized Activity

(71) Applicant: Bank of America Corporation, Charlotte, NC (US)

(72) Inventors: Brandon Weeks, Charlotte, NC (US); Craig Widmann, Chandler, AZ (US); John Tuders, Harrisburg, NC (US); Aron Megyeri, Kennett Square, PA (US); Robert D. Jones, Wilmington, DE (US); Shuang Lu, Phoenix, AZ (US); Amijo Bearley, Oxford, PA (US)

(21) Appl. No.: 15/009,057

(22) Filed: Jan. 28, 2016

(51) Int. Cl. G06Q 50/26

(52) U.S. Cl. CPC G06Q 50/265

(57) ABSTRACT

Methods, systems, and computer-readable media for identifying unauthorized activity events, assessing the unauthorized activity event and evaluating a potential impact of the unauthorized activity event are provided. In some examples, upon detection of an unauthorized activity event, merchant data may be received for a first evaluation time period. If a sufficient number of events has occurred in the first evaluation time period, additional data may be retrieved and analyzed to determine a control limit related to an expected rate of events. The number of events in the first evaluation time period may then be compared to the control limit and, if the number exceeds the control limit, a priority score for the merchant may be generated. Additional data, such as merchant category, particular state, and/or particular city data, may be analyzed in order to provide a more granular evaluation of a merchant.

### BACKGROUND

Aspects of the disclosure relate to computer hardware and software. In particular, one or more aspects of the disclosure generally relate to computer hardware and software for dynamically identifying unauthorized activity events and mitigating loss exposure.

Data breaches and other compromises occur often. It is important to protect entities against loss due to these data breaches. In order to aid in mitigating loss exposure, early detection of unauthorized activity, as well as further analysis of an unauthorized activity event in order to assess other users, entities, or the like, that might be exposed, is important. However, in order to fairly assess the potential loss exposure, it is important to consider various factor or features associated with the entity that may identify a tolerance for loss. For instance, larger entities may have a higher tolerance for loss, while smaller entities may have a lower tolerance because any loss could be damaging to the entity. Accordingly, assessing potential unauthorized activity at a granular level may aid in accurately identifying unauthorized access events, a cause or source of a data breach, and the like.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of the disclosure relate to computer systems that provide effective, efficient, and accurate ways of identifying unauthorized activity events, assessing the unauthorized activity event and evaluating a potential impact of the unauthorized activity event. In some examples, upon detection of an unauthorized activity event, merchant data may be received for a first evaluation time period. If a sufficient number of events has occurred in the first evaluation time period, additional data may be retrieved and analyzed to determine a control limit related to an expected rate of events. The number of events in the first evaluation time period may then be compared to the control limit and, if the number exceeds the control limit, a priority score for the merchant may be generated.

In other examples, additional data may be analyzed in order to provide a more granular evaluation of a merchant. For instance, data associated with a merchant category, particular state, and/or particular city may be aggregated and analyzed to more closely evaluation a merchant or particular merchant location.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1 depicts an illustrative operating environment in which various aspects of the disclosure may be implemented in accordance with one or more aspects described herein;

FIG. 2 depicts an illustrative block diagram of workstations and servers that may be used to implement the processes and functions of certain aspects of the present disclosure in accordance with one or more aspects described herein;

FIG. 3 depicts an illustrative computing platform for detecting unauthorized activity in accordance with one or more aspects described herein;

FIG. 4 is a flow chart depicting an illustrative method of detecting unauthorized activity and evaluating a merchant in accordance with one or more aspects described herein;

FIG. 5 is a flow chart depicting an illustrative method of detecting unauthorized activity and evaluating a merchant and category in accordance with one or more aspects described herein.

FIG. 6 is a flow chart depicting an illustrative method of detecting unauthorized activity and evaluating a merchant, category and state in accordance with one or more aspects described herein.

FIG. 7 is a flow chart depicting an illustrative method of detecting unauthorized activity and evaluating a merchant, category, state and city in accordance with one or more aspects described herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

As discussed herein, unauthorized activity and unauthorized activity events are relatively common. In order to protect entities again loss due to these unauthorized activity events, it is important to not only detect unauthorized activity but to detect the unauthorized activity quickly after an event in order to mitigate loss exposure. However, it is also beneficial to understand an entity's tolerance for loss due to these types of events. For instance, larger entities may be able to more easily absorb a loss, and thus may have a higher tolerance for loss than smaller entities for whom even one unauthorized activity event could be detrimental.

The systems and arrangements described herein may be used to detect unauthorized activity and also to evaluate merchants or other entities, both broadly and at a granular level, in order to understand the merchant's loss tolerance. In some instances, the loss tolerance may be evaluated at a location level (e.g., a merchant location in a particular city in a particular state). In some arrangements, each location of a merchant may be evaluated to understand a risk tolerance and whether a number of occurrences of unauthorized activity has exceeded an expected (or accepted) rate. This may aid in accounting for variations in merchant location due to size, volume of records or transactions, and the like. The system may also permit a customized view of loss tolerance for a merchant that accounts for the type of merchant, location, and the like.

The evaluation of the merchants, broadly and at a location or other level, may permit the system to prioritize merchants for further evaluation. For instance, if a merchant has a number of unauthorized activity events just slightly over an expected number, that merchant may be given a lower priority rating than another merchant that has a number of unauthorized activity events much greater than an expected number.

These and various other aspects and features will be described more fully herein.

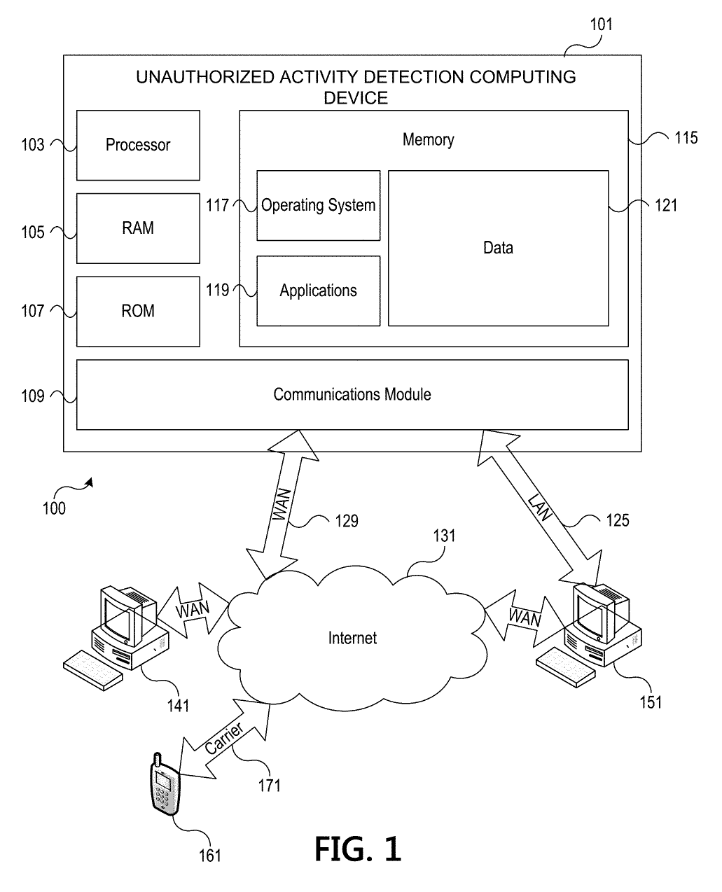

FIG. 1 depicts an illustrative operating environment in which various aspects of the present disclosure may be implemented in accordance with one or more example arrangements. Referring to FIG. 1, computing system environment 100 may be used according to one or more illustrative embodiments. Computing system environment 100 is only one example of a suitable computing environment and is not intended to suggest any limitation as to the scope of use or functionality contained in the disclosure. Computing system environment 100 should not be interpreted as having any dependency or requirement relating to any one or combination of components shown in illustrative computing system environment 100.

Computing system environment 100 may include unauthorized activity detection computing device 101 having processor 103 for controlling overall operation of unauthorized activity detection computing device 101 and its associated components, including random-access memory (RAM) 105, read-only memory (ROM) 107, communications module 109, and memory 115. Unauthorized activity detection computing device 101 may include a variety of computer readable media. Computer readable media may be any available media that may be accessed by unauthorized activity detection computing device 101, may be non-transitory, and may include volatile and nonvolatile, removable and non-removable media implemented in any method or technology for storage of information such as computer-readable instructions, object code, data structures, program modules, or other data. Examples of computer readable media may include random access memory (RAM), read only memory (ROM), electronically erasable programmable read only memory (EEPROM), flash memory or other memory technology, compact disk read-only memory (CD-ROM), digital versatile disks (DVD) or other optical disk storage, magnetic cassettes, magnetic tape, magnetic disk storage or other magnetic storage devices, or any other medium that can be used to store the desired information and that can be accessed by unauthorized activity detection computing device 101.

Although not required, various aspects described herein may be embodied as a method, a data processing system, or as a computer-readable medium storing computer-executable instructions. For example, a computer-readable medium storing instructions to cause a processor to perform steps of a method in accordance with aspects of the disclosed embodiments is contemplated. For example, aspects of method steps disclosed herein may be executed on a processor on unauthorized activity detection computing device 101. Such a processor may execute computer-executable instructions stored on a computer-readable medium.

Software may be stored within memory 115 and/or storage to provide instructions to processor 103 for enabling unauthorized activity detection computing device 101 to perform various functions. For example, memory 115 may store software used by unauthorized activity detection computing device 101, such as operating system 117, application programs 119, and associated database 121. Also, some or all of the computer executable instructions for unauthorized activity detection computing device 101 may be embodied in hardware or firmware. Although not shown, RAM 105 may include one or more applications representing the application data stored in RAM 105 while unauthorized activity detection computing device 101 is on and corresponding software applications (e.g., software tasks) are running on unauthorized activity detection computing device 101.

Communications module 109 may include a microphone, keypad, touch screen, and/or stylus through which a user of unauthorized activity detection computing device 101 may provide input, and may also include one or more of a speaker for providing audio output and a video display device for providing textual, audiovisual and/or graphical output. Computing system environment 100 may also include optical scanners (not shown). Exemplary usages include scanning and converting paper documents, e.g., correspondence, receipts, and the like, to digital files.

Unauthorized activity detection computing device 101 may operate in a networked environment supporting connections to one or more remote computing devices, such as computing devices 141, 151, and 161. Computing devices 141, 151, and 161 may be personal computing devices or servers that include any or all of the elements described above relative to unauthorized activity detection computing device 101. Computing device 161 may be a mobile device (e.g., smart phone) communicating over wireless carrier channel 171.

The network connections depicted in FIG. 1 may include local area network (LAN) 125 and wide area network (WAN) 129, as well as other networks. When used in a LAN networking environment, unauthorized activity detection computing device 101 may be connected to LAN 125 through a network interface or adapter in communications module 109. When used in a WAN networking environment, unauthorized activity detection computing device 101 may include a modem in communications module 109 or other means for establishing communications over WAN 129, such as Internet 131 or other type of computer network. The network connections shown are illustrative and other means of establishing a communications link between the computing devices may be used. Various well-known protocols such as transmission control protocol/Internet protocol (TCP/IP), Ethernet, file transfer protocol (FTP), hypertext transfer protocol (HTTP) and the like may be used, and the system can be operated in a client-server configuration to permit a user to retrieve web pages from a web-based server. Any of various conventional web browsers can be used to display and manipulate data on web pages.

The disclosure may be operational with other computing system environments or configurations. Examples of computing systems, environments, and/or configurations that may be suitable for use with the disclosed embodiments include, but are not limited to, personal computers (PCs), server computers, hand-held or laptop devices, smart phones, multiprocessor systems, microprocessor-based systems, set top boxes, programmable consumer electronics, network PCs, minicomputers, mainframe computers, distributed computing environments that include any of the above systems or devices, and the like configured with particular hardware and/or software to perform the functions and processes described herein.

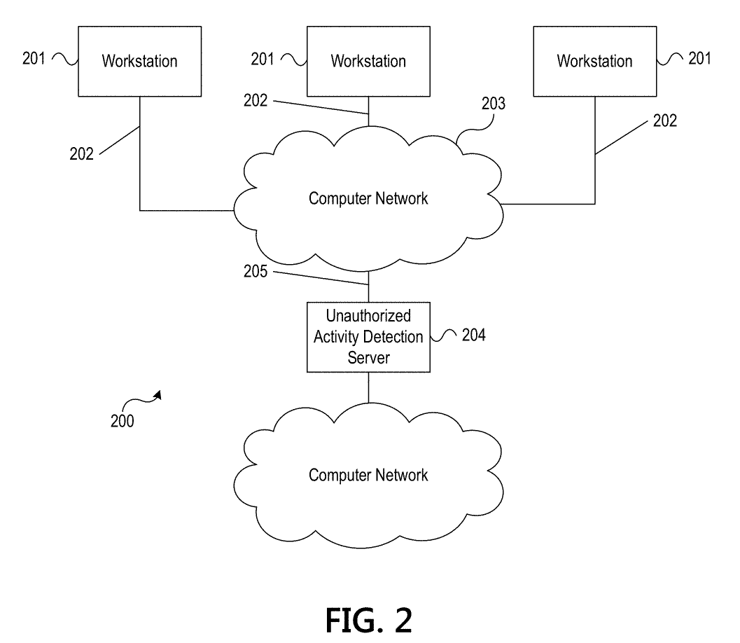

FIG. 2 depicts an illustrative block diagram of workstations and servers that may be used to implement the processes and functions of certain aspects of the present disclosure in accordance with one or more example embodiments. Referring to FIG. 2, illustrative system 200 may be used for implementing example embodiments according to the present disclosure. As illustrated, system 200 may include one or more workstation computers 201. Workstation 201 may be, for example, a desktop computer, a smartphone, a wireless device, a tablet computer, a laptop computer, and the like. Workstations 201 may be local or remote, and may be connected by one of communications links 202 to computer network 203 that is linked via communications link 205 to unauthorized activity detection server 204. In system 200, unauthorized activity detection server 204 may be any suitable server, processor, computer, or data processing device, or combination of the same configured with particular hardware and/or software to perform the functions and processes described herein. Unauthorized activity detection server 204 may be used to process occurrences of unauthorized activity, process vast amounts of data based on particular criteria, to generate points of comparison (e.g., potential additional occurrences of unauthorized activity that may indicate a compromise of a point of sale system) and/or to evaluate entities at a granular level (e.g., determine unauthorized activity standards and occurrences at a particular merchant, merchant location, within a particular category of goods or services provided by the merchant, and the like).

Computer network 203 may be a suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 202 and 205 may be communications links suitable for communicating between workstations 201 and unauthorized activity detection server 204, such as network links, dial-up links, wireless links, hard-wired links, as well as network types developed in the future, and the like.

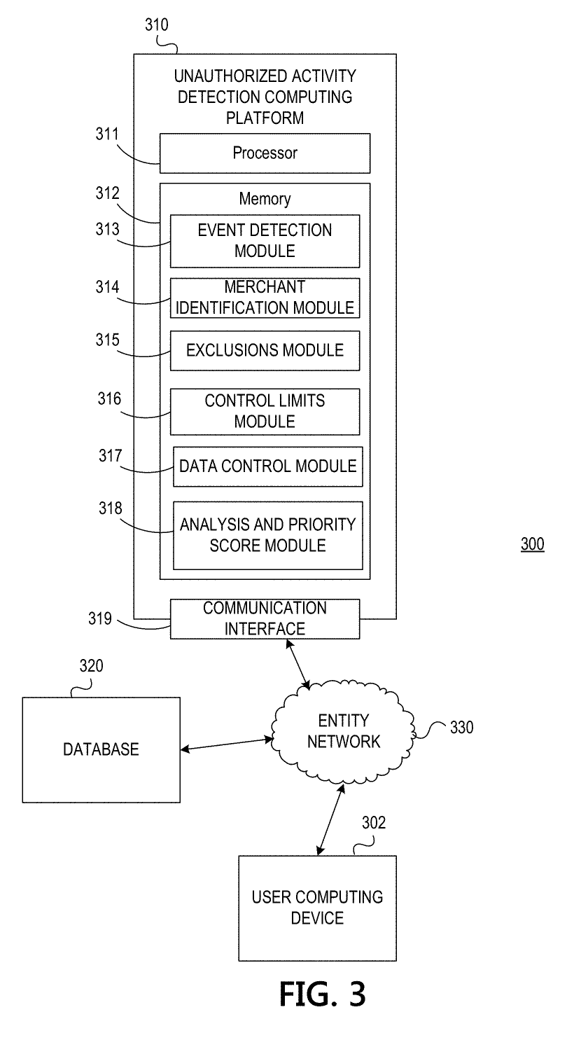

FIG. 3 depicts an environment 300 including an illustrative computing platform for detecting unauthorized activity and evaluating merchants according to one or more aspects described herein. Merchants may include any of various types of entities at which unauthorized activity events may occur. For instance, merchants may include retail establishments, online establishments, hotels, restaurants, universities, service providers, and the like. In some arrangements, a merchant may include any entity at which a record occurs that may be subject to unauthorized activity. In at least some examples, a record may include a transaction such as a purchase, payment, or the like, made via one or more known forms of payment (e.g., credit, debit, checking account, or the like). The merchant may include a single location or a plurality of locations, with the plurality of locations being located in one or more cities, in one or more states, and the like. In some examples, a merchant location may be identified by a unique identifier (such as a store number) and this unique identifier may be used to sort data, compare data for a particular location, and the like.

The environment 300 includes an unauthorized activity detection computing platform 310, which may include one or more processors 311, memory 312, and communication interface 319. A data bus may interconnect processor(s) 311, memory 312, and communication interface 319. Communication interface 319 may be a network interface configured to support communication between unauthorized activity detection computing platform 310, and one or more networks (e.g., network 330). Memory 312 may include one or more program modules having instructions that when executed by processor(s) 311 cause unauthorized activity detection computing platform 310 to perform one or more functions described herein and/or one or more databases that may store and/or otherwise maintain information which may be used by such program modules and/or processor(s) 311. In some instances, the one or more program modules and/or databases may be stored by and/or maintained in different memory units of the unauthorized activity detection computing platform 310 and/or by different computer systems that may form and/or otherwise make up the unauthorized activity detection computing platform 310.

For example, memory 312 may include an event detection module 313. The event detection module 313 may include hardware and/or software configured to perform various functions within the unauthorized activity detection computing platform 310. For instance, the event detection 313 may identify (or receive notification of) an instance or event of unauthorized activity (e.g., use of a person's payment card without their authorization, use of a person's checking account without their authorization, or the like). The unauthorized activity event may be detected by systems monitoring accounts, payment cards, and the like, associated with a user. In another example, the event may be detected by a user recognizing the occurrence of unauthorized activity and reporting it to the entity (e.g., financial institution). In still other examples, the event may be reported by the merchant or other entity at which the unauthorized activity occurred (e.g., in the event of, for example, a data breach at a merchant).

Memory 312 may include a merchant identification module 314. The merchant identification module 314 may include hardware and/or software configured to perform various functions within the unauthorized activity detection computing platform 310. For instance, the merchant identification module 314 may, based on detection of an unauthorized activity event, identify additional merchants for unauthorized activity evaluation. In some examples, the merchant identification module 314 may identify a user associated with the unauthorized activity event (e.g., a user associated with the device or account on which the unauthorized activity occurred) and may identify a plurality of other merchants at which the user generated a record (e.g., made a purchase, conducted business, or the like). The plurality of other merchants may then be evaluated to determine whether additional unauthorized activity events occurred at those merchants, as will be discussed more fully herein.

In some examples, the merchant identification module 314 may also identify other devices or users that generated a record at the merchant at which the unauthorized activity event occurred. Accordingly, notifications and further analysis of those devices and/or users may be performed in order to aid in identifying a source of the unauthorized activity event.

Memory 312 may further include an exclusions module 315. The exclusions module 315 may include hardware and/or software configured to perform various functions within the unauthorized activity detection computing platform 310. For instance, the exclusions module 315 may determine one or more exclusion rules to apply to data (such as merchant data) and/or may apply the exclusion rules to exclude one or more merchants, merchant locations, and the like, from analyzed data. The exclusions module 315 may work in conjunction with control limits module 316 to exclude one or more merchants, or the like. Some example rules that may be used to exclude one or more merchants, merchant locations, or the like may include an indication of a downward trend in unauthorized activity events (e.g., the number of unauthorized activity events for a certain period is improving, an indication that a merchant has seen at least a predetermined threshold number of weeks with no unauthorized activity events, an indication of high degrees of variation within a trend of unauthorized activity events, and the like.

As indicated above, the memory 312 may further include a control limits module 316 that may include hardware and/or software configured to perform various functions within the unauthorized activity detection computing platform 310. The control limits module 316 may analyze data to determine control limits for a number of unauthorized activity events for a particular merchant, merchant category, merchant state, merchant city, merchant location, or the like. For example, the control limits module 316 may receive data (e.g., from data control module 317) related to authorization of payments, or the like, and claim data (e.g., data related to an unauthorized activity event). In some examples, the control limits module 316 may analyze data for a particular merchant for a predetermined time period, such as one year prior or 52 weeks prior to a current date, a designated start data, or the like. This data may be analyzed to determine a rate at which unauthorized activity events occur at the merchant, at each merchant location, and the like. The rate of unauthorized activity events may be per week, per month, per year, or the like. In some examples, the analysis of the data may also determine a percentage of authorizations for which a claim is made (e.g., a percent of authorizations for which an unauthorized activity event is identified). In some arrangements, the merchant data may be analyzed at the merchant level, at a merchant and category level, at a merchant, category and state level, and/or at a merchant, category, state and city level. This information may then be used to establish control limits for a particular merchant, merchant location, merchant category, and the like which may indicate a baseline or expected rate or percentage of unauthorized activity events.

For example, if data for Company X is collected and analyzed for one year prior to the current date, the data may indicate that, historically, approximately 2% of Company X authorizations included unauthorized activity events. However, because the data is evaluated at a location level as well as at the company level, the data may show that Company X, Location 10 has approximately 6% of authorizations as unauthorized activity events. Accordingly, a baseline or control limit may be set for Company X at 2% and Company X, Location 10 at 6%, to provide an accurate comparison to identify potential issues, as will be discussed more fully herein. The control limit may then be used to identify whether a number of unauthorized activity events in a particular time period being evaluated is outside an expected number.

Evaluating merchants at an overall company level, as well as by location, merchant category, or the like, allows for the system to recognize variations due to size, transaction volume, location, and the like. For example, in continuing the example above, Company X Location 3 may have a 1% control but may have much lower volume than Company X, Location 10. Accordingly, even a small increase to 1.5% may be indicative of an issue, while a similar increase at Location 10 might not be as significant. This may aid in understanding a loss exposure tolerance for a merchant, both at a broad overall merchant level, and at a more granular level (e.g., by location, by state, by city, or the like). Identifying control limits by merchant may also aid in accounting for different loss tolerances between different merchants, different types of merchants, merchants of different size or record volume, and the like. This may aid in accurately when potential issues should be further analyzed (which may be a small number of events for a smaller merchant) and when the number of events is within an expected level and, thus, further analysis may be a lower priority than for other merchants with a more urgent need.

As mentioned above, the memory 312 may further include a data control module 317. The data control module 317 may include hardware and/or software configured to perform various functions within the unauthorized activity detection computing platform 310. For instance, the data control module 317 may regulate or control the data being processed. Because such vast amounts of data are being analyzed to determine unauthorized activity events, in order to reduce the computing resources needed to process the data, the data control module 317 may regulate the amount and/or type of data transmitted for processed. For instance, the data control module 317 may receive exclusions and the like from one or more other modules within the unauthorized activity detection computing platform 310 and may control an amount of data transmitted for further evaluation (e.g., to the analysis and priority score module 318) based on excluded merchants. In another example, the data control module 317 may extract data to be processed and may transmit that data for processing. For instance, if merchant data for a particular state and city is being evaluated, the data control module 317 may extract the desired data and transmit it for processing. In some examples, the data may be retrieved from a database associated with or external to the unauthorized activity detection computing platform 310 that may be in communication with the unauthorized activity detection computing platform 310, such as database 320. This aids in reducing the computing resources used by the computing platform 310 to analyze the data and may cause the system to work faster and more efficiently because only the data to be processed for a particular merchant, merchant state, merchant city, or the like, may be transmitted to the computing platform 310 for processing.

The memory 312 may further include an analysis and priority score module 318. The analysis and priority score module 318 may include hardware and/or software configured to perform various functions within the unauthorized activity determination computing platform 310. For instance, the analysis and priority score module 318 may evaluate merchant data (including, in some examples, category, state and/or city data) provided by the data control module 317 (e.g., with excluded data and/or merchants removed) to identify merchants, merchant locations, or the like, for further analysis to determine an extent of unauthorized activity and/or overlap with other users who had an unauthorized activity event. The analysis and priority score module 318 may, in at least some examples, generate a priority score for a merchant which identifies a priority for further analyzing the merchant. Higher priority merchants may be evaluation before lower priority merchants in at least some instances.

In some examples, the analysis and priority score module 318 may analyze merchant data for a predetermined time period (e.g., a first evaluation period) and may determine whether the merchant had unauthorized activity events. If so, analysis and priority score module 318 may determine whether a number of unauthorized activity events in the first evaluation period exceeded a control limit for the merchant. For any merchants exceeding the control limit (who are not excluded), a priority score may be generated and merchants may then be further analyzed to evaluate the unauthorized activity events, attempt to determine a cause, or the like.

The data provided by the data control module 317 may then be further analyzed by the analysis and priority score module 318 to evaluate at a more granular level, as discussed herein. For instance, data for merchants may be further filtered to analyze merchant data for a particular category. The category may be a category of goods or services for the merchant. For instance, the category may be a category of goods or services provided by the merchant. For example, if the merchant is a hotel, the hotel may provide rooms which may have a first merchant category (which may include a first code or identifier). The hotel may also offer food (e.g., room service, or the like) and those purchases may have a second, different merchant category (which may have a second code or identifier different from the first code or identifier). The hotel may also offer items for sale in, for instance, a gift shop. Those purchases may have a third merchant category (with a third code or identifier) different from the first and second merchant category codes. So, although all purchases may be recorded as between a customer and the same merchant, the merchant category and/or code or identifier may aid in distinguishing between different types of purchases made from the same merchant. This information may be used to further assess the merchant and category data and provide a priority score for the merchant and category data.

In another example, the data for the merchant and category may be further filtered to analyze data for a particular state to determine a priority score for a merchant and category for a particular state. The state may be a state in which the unauthorized activity event occurred, a state associated with the user, or the like. In still other examples, the data for the merchant, category and state may be further filtered to analyze a particular merchant city or location to determine a priority score for the merchant, category, state and city or particular location. Based on the score generated, the merchant, merchant location, or the like, may be further evaluated to determine extent of unauthorized activity, cause, or other factors.

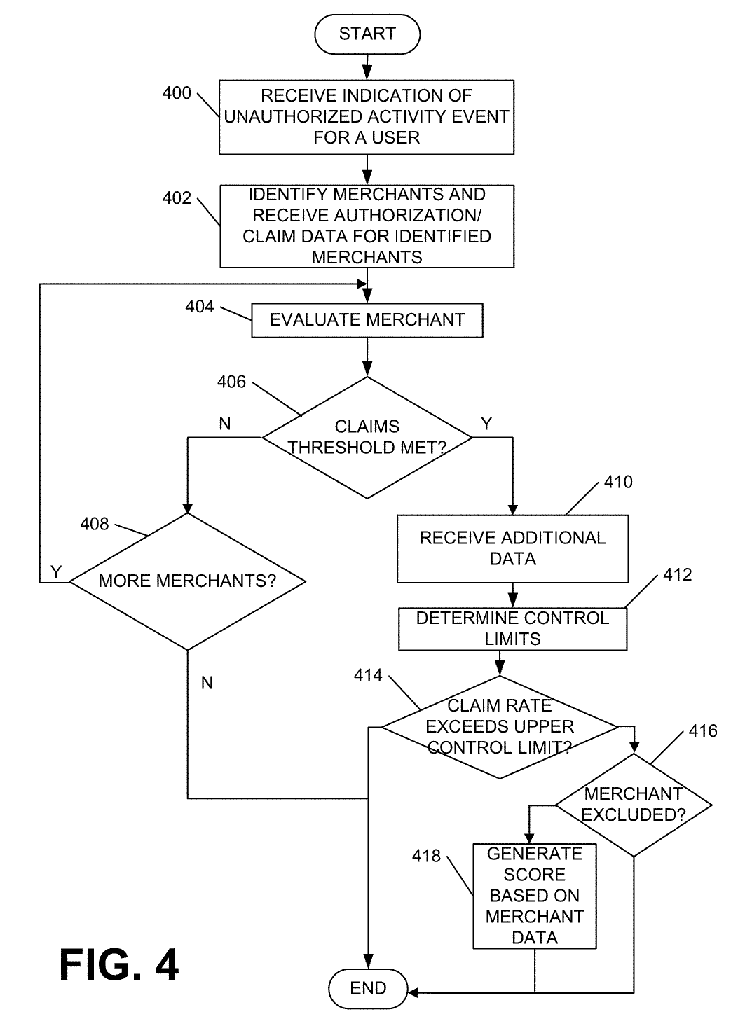

FIG. 4 is a flow chart illustrating one example method of evaluating merchant data to generate a score to be used in prioritizing review of merchant data according to one or more aspects described herein. In step 400, an unauthorized activity event is detected and/or received by the system. As discussed herein, an unauthorized activity event may include use of a payment device by an unauthorized individual, use of a checking account by an unauthorized individual, and the like. The unauthorized individual may obtain the account, payment device, or the like information in a variety of ways (e.g., a data breach, stolen device, or the like). The unauthorized activity event may be associated with a user (e.g., the authorized user of the payment device, or the like).

In step 402, other merchants at which the user generated a record (e.g., made a purchase, payment or the like) may be identified (e.g., based on the user, account, or device associated with the identified unauthorized activity event), and authorization and/or claim data for each identified merchant may be received. In some examples, the data received may be for a first predefined period of time, such as a preceding week, month, or the like. The first predefined time period may be a first evaluation period. The merchants may be identified from previous data indicating records between the user and the merchant (e.g., payment records, authorization records, and the like).

In step 404 a merchant may be evaluated. For instance, the system may evaluate the merchant for the first evaluation period to determine whether that particular merchant may be a source of access to the payment or other information being used in the unauthorized activity event.

In step 406, a determination may be made as to whether the merchant data for the first evaluation period meets a claims (e.g., number of unauthorized activity events) threshold. For instance, the system may analyze the data received to determine whether a number of claims (e.g., unauthorized activity events) in the first evaluation period is greater than a predetermined threshold. The predetermined threshold may be based on a type of merchant, size of merchant, volume of transactions at the merchant, on historical merchant data for unauthorized activity events, or the like.

If, in step 406, the data received does not include a number of events greater than the predetermined threshold, the system may determine whether there are additional merchants to evaluate in step 408. If so, the process may return to step 404 to evaluate another merchant. If not, the process may end.

Alternatively, if, in step 406, the number of events in the first evaluation period meets or exceeds the predetermined threshold, additional data for the merchant may be received (e.g., for a second, longer evaluation period) and analyzed in step 410. For instance, data for a second time period (second evaluation period) extending farther back in time may be received and analyzed. For instance, if the first evaluation period was one week, the second evaluation period may be a previous one month, year, 52 week period, or other predefined date range.

In step 412, control limits for a merchant may be determined. The control limits may be determined by analyzing data from the second evaluation period to determine a rate or expected number of unauthorized activity events. The rate may be determined per week, per month, or the like. This determined rate for the second evaluation period may be used as a control limit to understand a baseline or expected number of unauthorized activity events.

In step 414, a determination is made as to whether a number of unauthorized activity events in the first evaluation period exceeds the control limit determined in step 412. If not, the process may end. If so, a determination is made as to whether the merchant meets one or more rules for exclusion in step 416. For instance, some merchants (and associated data) may be excluded from further analysis. Some example exclusion rules may include no occurrences of unauthorized activity, timing of the unauthorized activity events being outside a specified time period, or the like. If the merchant meets one or more exclusion rules in step 416, the merchant may be excluded from scoring and/or further analysis at this time.

Alternatively, if the merchant is not excluded in step 416, a priority score for the merchant may be generated in step 418. The score may indicate a priority level for further analysis of the merchant. For instance, merchants having a higher priority score may be evaluated further before merchants having a lower priority score. Additionally or alternatively, merchants having a higher priority score may receive additional evaluation or analysis that merchants having a lower priority score might not receive.

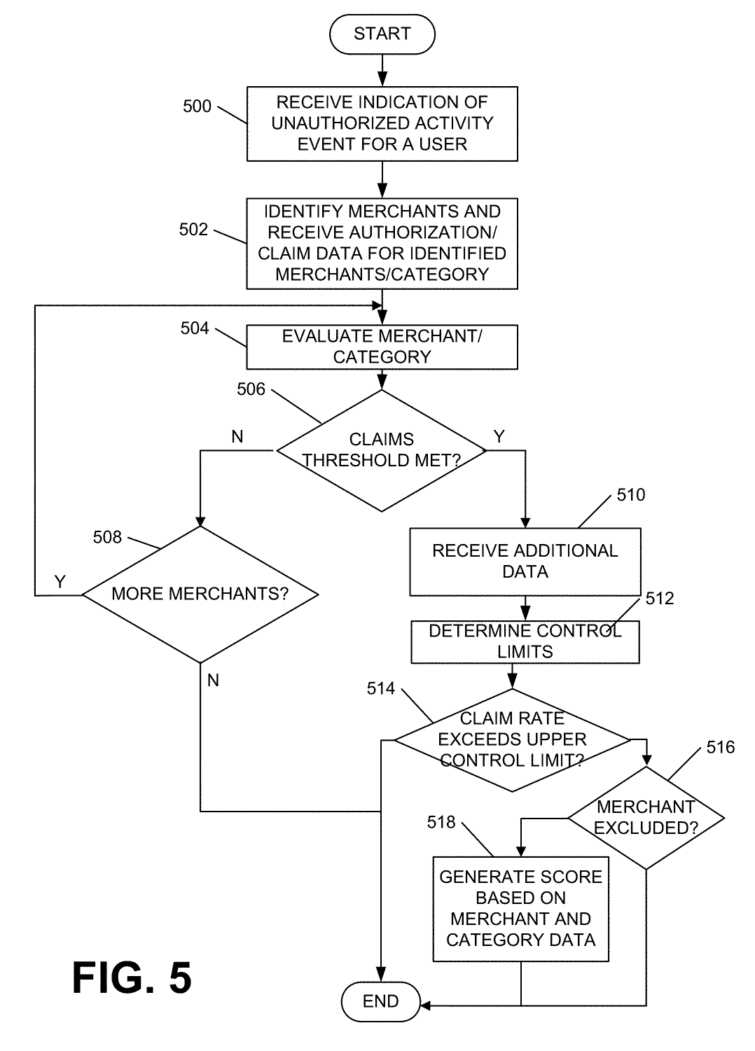

FIG. 5 is a flow chart illustrating one example method of evaluating merchant and category data to generate a priority score to be used in prioritizing review of a merchant and/or merchant data according to one or more aspects described herein. In step 500, similar to step 400 in FIG. 4, an unauthorized activity event is detected and/or received by the system. As discussed herein, an unauthorized activity event may include use of a payment device by an unauthorized individual, use of a checking account by an unauthorized individual, and the like. The unauthorized individual may obtain the account, payment device, or the like information in a variety of ways (e.g., a data breach, stolen device, or the like). The unauthorized activity event may be associated with a user (e.g., the authorized user of the payment device, or the like).

In step 502, other merchants at which the user generated a record (e.g., made a purchase, payment or the like) may be identified (e.g., based on the user, account, or device associated with the identified unauthorized activity event, and authorization and/or claim data for each identified merchant and category may be received. In some examples, the data received may be for a first predefined period of time (e.g., a first evaluation period), such as a preceding week, month, or the like, or for a particular date range identified for evaluation. The merchants may be identified from previous data indicating authorizations or records between the user and the. The category may be a category of goods, services, or the like, associated with the merchant. Thus, a merchant may operate in several different categories and, accordingly, data for a particular category for the particular merchant may be received in step 502, rather than all merchant data (as discussed with respect to the arrangement of FIG. 4).

In step 504 a merchant and category may be evaluated. For instance, the system may evaluate the merchant and category (e.g., the data received in step 502) to evaluate authorizations and unauthorized activity events and/or determine whether that particular merchant may be a source of access to the payment or other information being used in the unauthorized activity event.

In step 506, evaluation of the merchant and category data may include a determination as to whether the merchant/category data for the first evaluation period meets a claims threshold. For instance, the system may analyze the data received to determine whether a number of claims (e.g., unauthorized activity events) in the evaluation period is greater than a predetermined threshold. The predetermined threshold may be based on a type of merchant, size of merchant, volume of transactions at the merchant, on historical merchant data for unauthorized activity events, or the like.

If, in step 506, the data received does not include a number of events greater than the predetermined threshold, the system may determine whether there are additional merchants to evaluate in step 508. If so, the process may return to step 504 to evaluate another merchant/category. If not, the process may end.

Alternatively, if, in step 506, the number of events in the first evaluation period meets or exceeds the predetermined threshold, additional data for the merchant/category may be received and analyzed in step 510. For instance, data for a second time period (e.g., a second evaluation period) extending farther back in time may be received and analyzed. For instance, if the first evaluation period was one week, the second evaluation period may be a previous one month, one year, 52 week period, or specified date range may be received and analyzed.

In step 512, control limits for a merchant/category may be determined. The control limits may be determined by analyzing data from the second evaluation period to determine a rate or expected number or percentage of unauthorized activity events. The rate may be determined per week, per month, or the like. This determined rate for the second evaluation period may be used as a control limit to understand a baseline or expected number of unauthorized activity events in a given time period.

In step 514, a determination is made as to whether a number of unauthorized activity events in the first evaluation period exceeds the control limit determined in step 512. If not, the process may end. If so, a determination is made as to whether the merchant/category meets one or more rules for exclusion in step 516. For instance, some merchants (and associated data) may be excluded from further analysis. Some example exclusion rules may include no occurrences of unauthorized activity, timing of the unauthorized activity events being outside a specified time period, or the like. If the merchant/category meets one or more exclusion rules in step 516, the merchant may be excluded from scoring and/or further analysis at this time.

Alternatively, if the merchant/category is not excluded in step 516, a priority score for the merchant may be generated in step 518. The score may indicate a priority level for further analysis of the merchant and category. For instance, merchants/categories having a higher priority score may be evaluated further before merchants/categories having a lower priority score. Additionally or alternatively, merchants/categories having a higher priority score may receive additional evaluation or analysis that merchants/categories having a lower priority score might not receive.

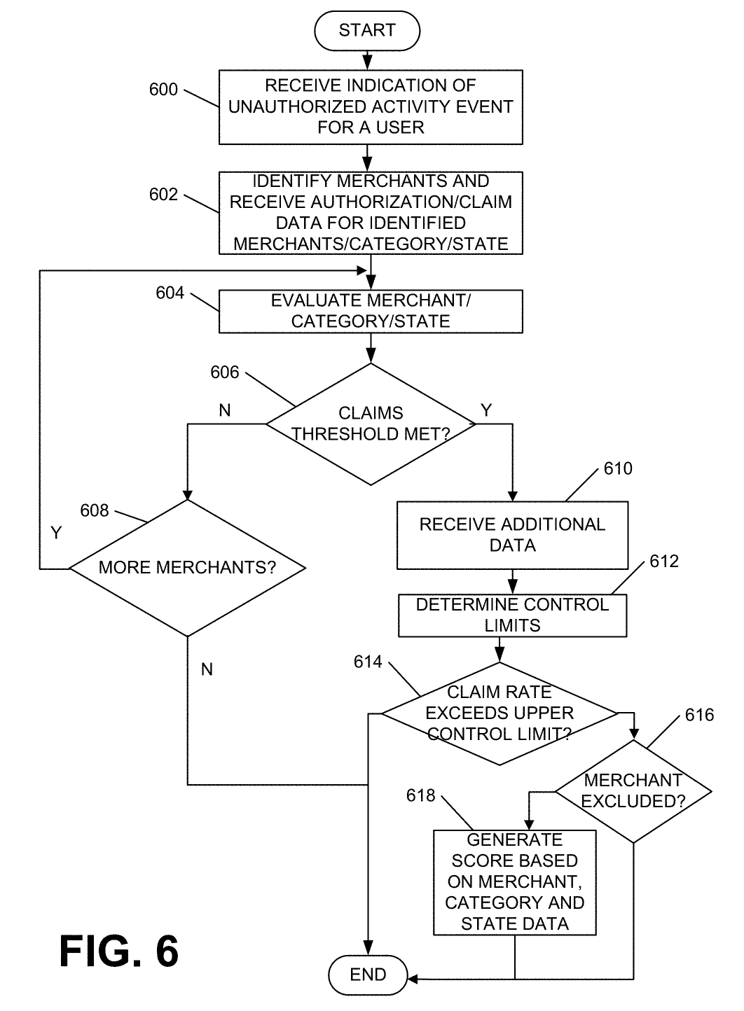

FIG. 6 is a flow chart illustrating one example method of evaluating merchant, category and state data to generate a score to be used in prioritizing review of a merchant and/or merchant data according to one or more aspects described herein. In step 600, similar to step 400 in FIG. 4 and step 500 in FIG. 5, an unauthorized activity event is detected and/or received by the system. As discussed herein, an unauthorized activity event may include use of a payment device by an unauthorized individual, use of a checking account by an unauthorized individual, and the like. The unauthorized individual may obtain the account, payment device, or the like information in a variety of ways (e.g., a data breach, stolen device, or the like). The unauthorized activity event may be associated with a user (e.g., the authorized user of the payment device, or the like).

In step 602, other merchants at which the user generated a record (e.g., made a purchase, payment or the like) may be identified (e.g., based on the user, account, or device associated with the identified unauthorized activity event), and authorization and/or claim data for each merchant, category and state of the merchant location associated with the user may be received. That is, merchants with which the user has conducted a transaction may be identified and authorization and/or claim (e.g., unauthorized activity event) data for a first evaluation period may be received for the merchant, a particular category of goods or services provided by the merchant, and for merchant locations within a particular state (e.g., the state associated with the user, the state in which the unauthorized activity event in step 600 occurred, or the like). Thus, a more granular analysis of the merchant may be performed since the data being considered is data for the merchant locations in a particular state.

In some examples, as discussed above, the data received may be for a first predefined period of time (e.g., a first evaluation period), such as a preceding week, month, or the like, or for a particular date range identified for evaluation. The merchants may be identified from previous data indicating records between the user and the merchant (e.g., credit card transactions, debit card transactions, and the like). The category may be a category of goods, services, or the like, associated with the merchant. Thus, a merchant may operate in several different categories and, accordingly, data for a particular category for the particular merchant may be received in step 602, rather than all merchant data (similar to the arrangement of FIG. 4). State information is also used to further filter the data. Accordingly, the data received in step 602 may include only data from merchant locations within a particular state in a particular category. Not only does this provide a more focused overview of unauthorized activity events but it also controls an amount of data being processed by the system in order to conserve computing resources and efficient analyze data.

In step 604 a merchant/category/state may be evaluated. For instance, the system may evaluate the merchant, category, and state (e.g., the data received in step 602) to evaluate unauthorized activity events and/or determine whether that particular merchant may be a source of access to the payment or other information being used in the unauthorized activity event.

In step 606, evaluation of the merchant, category and state data may include a determination as to whether the merchant/category/state data for the first evaluation period meets a claims threshold. For instance, the system may analyze the data received to determine whether a number of claims (e.g., unauthorized activity events) is greater than a predetermined threshold. The predetermined threshold may be based on a type of merchant, size of merchant, volume of transactions at the merchant, on historical merchant data for unauthorized activity events, or the like.

If, in step 606, the data received does not include a number of events greater than the predetermined threshold, the system may determine whether there are additional merchants to evaluate in step 608. If so, the process may return to step 604 to evaluate another merchant/category. If not, the process may end.

Alternatively, if, in step 606, the number of events in the first evaluation period meets or exceeds the predetermined threshold, additional data for the merchant/category/state may be received and analyzed in step 610. For instance, data for a second evaluation period (e.g., second predefined time period) extending farther back in time may be received and analyzed. For instance, if the first evaluation period was one week, data for the merchant, category and state for the second evaluation period may be for a previous one month, one year, or specified date range may be received and analyzed.

In step 612, control limits for a merchant/category/state may be determined. The control limits may be determined by analyzing the data received for the second evaluation period to determine an expected or baseline rate, number or percentage of unauthorized activity events. The rate may be determined per week, per month, or the like. This determined rate for the previous time period may be used as a control limit to understand a baseline or expected number of unauthorized activity events in a given time period.

In step 614, a determination is made as to whether a number of unauthorized activity events in the first evaluation period exceeds the control limit determined in step 612. If not, the process may end. If so, a determination is made as to whether the merchant/category/state meets one or more rules for exclusion in step 616. For instance, some merchants (and associated data) may be excluded from further analysis. Some example exclusion rules may include no occurrences of unauthorized activity, timing of the unauthorized activity events being outside a specified time period, or the like. If the merchant/category meets one or more exclusion rules in step 616, the merchant may be excluded from scoring and/or further analysis at this time.

Alternatively, if the merchant/category/state is not excluded in step 616, a priority score for the merchant/category/state may be generated in step 618. The score may indicate a priority level for further analysis of the merchant/category/state. For instance, merchants/categories/states having a higher priority score may be evaluated further before merchants/categories/states having a lower priority score. Additionally or alternatively, merchants/categories/states having a higher priority score may receive additional evaluation or analysis that merchants/categories/states having a lower priority score might not receive.

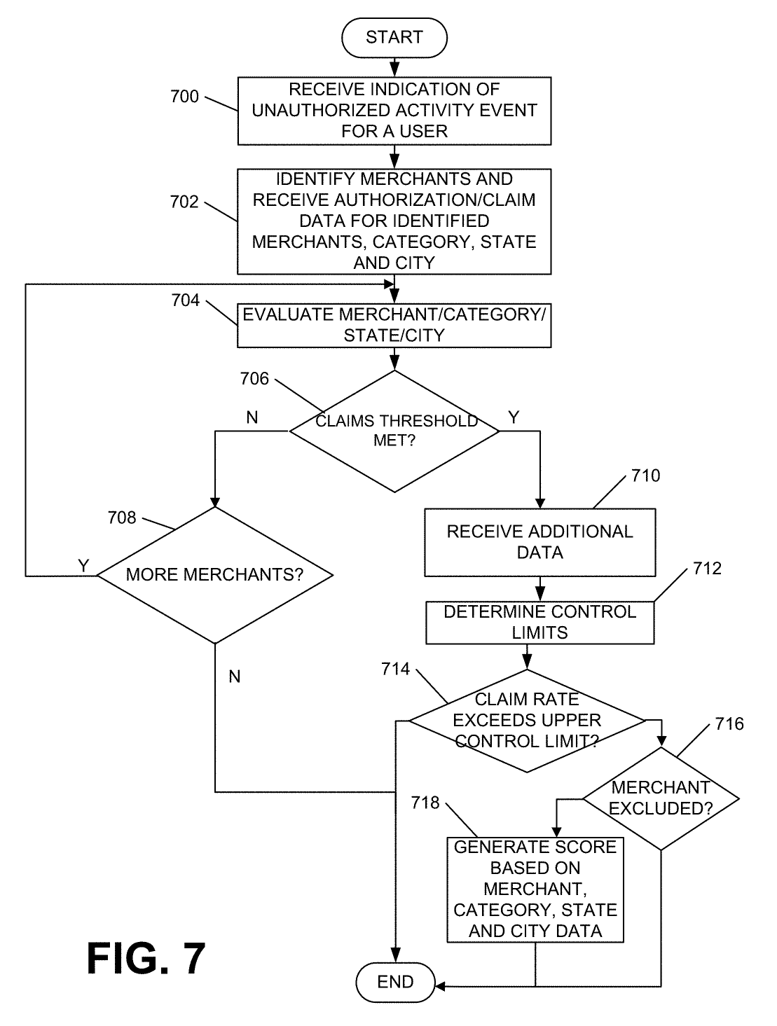

FIG. 7 is a flow chart illustrating one example method of evaluating merchant, category, state, and city data to generate a priority score to be used in prioritizing review of a merchant and/or merchant data according to one or more aspects described herein. In step 700, similar to step 400 in FIG. 4, step 500 in FIG. 5, and step 600 in FIG. 6, an unauthorized activity event is detected and/or received by the system. As discussed herein, an unauthorized activity event may include use of a payment device by an unauthorized individual, use of a checking account by an unauthorized individual, and the like. The unauthorized individual may obtain the account, payment device, or the like information in a variety of ways (e.g., a data breach, stolen device, or the like). The unauthorized activity event may be associated with a user (e.g., the authorized user of the payment device, or the like).

In step 702, other merchants at which the user generated a record (e.g., made a purchase, payment or the like) may be identified (e.g., based on the user, account, or device associated with the identified unauthorized activity event), and authorization and/or claim data for each merchant, category, state and city of the merchant identified as associated with the user may be received. That is, merchants with which the user has conducted a transaction in the first predefined period of time (e.g., first evaluation period) may be identified and authorization and/or claim (e.g., unauthorized activity event) data may be received for the merchant, a particular category of the merchant, for merchant locations within a particular state (e.g., the state associated with the user, the state in which the unauthorized activity event in step 600 occurred, or the like), and merchant locations within a particular city within the state (e.g., the city in which the unauthorized activity event occurred, a city associated with the user, or the like). Thus, a more granular analysis of the merchant may be performed since the data being considered is data for the merchant locations in a particular city and state.

In some examples, as discussed above, the data received may be for a first evaluation period, such as a preceding week, month, or the like, or for a particular date range identified for evaluation. The merchants may be identified from previous data indicating records between the user and the merchant (e.g., purchases, payments, and the like). The category may be a category of goods, services, or the like, associated with the merchant. Thus, a merchant may operate in several different categories and, accordingly, data for a particular category for the particular merchant may be received in step 702, rather than all merchant data (similar to the arrangement of FIG. 4). State information is also used to further filter the data, similar to the arrangement of FIG. 6. In addition, city information may be used to further filter the data. Accordingly, in some examples, the data received in step 702 may include data from merchant locations within a particular city, in a particular state in a particular category. Not only does this provide a more focused overview of unauthorized activity events but it also controls an amount of data being processed by the system in order to conserve computing resources and efficient analyze data.

In step 704 a merchant/category/state/city may be evaluated. For instance, the system may evaluate the merchant, category, state and city (e.g., the data received in step 702) to evaluate unauthorized activity events and/or determine whether that particular merchant may be a source of access to the payment or other information being used in the unauthorized activity event.

In step 706, evaluation of the merchant, category, state and city data may include a determination as to whether the merchant/category/state/city data meets a claims threshold. For instance, the system may analyze the data received to determine whether a number of claims (e.g., unauthorized activity events) in the first evaluation period is greater than a predetermined threshold. The predetermined threshold may be based on a type of merchant, size of merchant, volume of transactions at the merchant, on historical merchant data for unauthorized activity events, or the like.

If, in step 706, the data received does not include a number of events greater than the predetermined threshold, the system may determine whether there are additional merchants to evaluate in step 708. If so, the process may return to step 704 to evaluate another merchant/category. If not, the process may end.

Alternatively, if, in step 706, the number of events in the first evaluation period meets or exceeds the predetermined threshold, additional data for the merchant/category/state may be received and analyzed in step 710. For instance, data for a second evaluation period (e.g., a second time period) extending farther back in time may be received and analyzed. For instance, if the first evaluation period was one week, the second evaluation period may be a previous one month, one year, or specified date range may be received and analyzed.

In step 712, control limits for a merchant/category/state/city may be determined. The control limits may be determined by analyzing data received from the second evaluation period to determine a rate, number or percentage of unauthorized activity events. The rate may be determined per week, per month, or the like. This determined rate for the previous time period may be used as a control limit to understand a baseline or expected number of unauthorized activity events in a given time period.

In step 714, a determination is made as to whether a number of unauthorized activity events in the first evaluation period exceeds the control limit determined in step 712. If not, the process may end. If so, a determination is made as to whether the merchant/category/state/city meets one or more rules for exclusion in step 716. For instance, some merchants (and associated data) may be excluded from further analysis. Some example exclusion rules may include no occurrences of unauthorized activity, timing of the unauthorized activity events being outside a specified time period, or the like. If the merchant/category meets one or more exclusion rules in step 716, the merchant may be excluded from scoring and/or further analysis at this time.

Alternatively, if the merchant/category/state/city is not excluded in step 716, a priority score for the merchant/category/state/city may be generated in step 718. The score may indicate a priority level for further analysis of the merchant/category/state/city. For instance, merchants/categories/states/cities having a higher priority score may be evaluated further before merchants/categories/states/cities having a lower priority score. Additionally or alternatively, merchants/categories/states/cities having a higher priority score may receive additional evaluation or analysis that merchants/categories/states/cities having a lower priority score might not receive.

As discussed herein, the systems and arrangements described provide an efficient and effective way to investigate merchants associated with or potentially associated with an unauthorized activity event. In some examples, the arrangements described may include an iterative process that analyzes narrowing characteristics of the authorization and claim data. This may permit evaluation of merchants at a granular level (e.g., at a category level, state level, city level, or the like) which may aid in accurately determining when a number of unauthorized activity events is outside an expected number.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may comprise one or more non-transitory computer-readable media.

As described herein, the various methods and acts may be operative across one or more computing servers or platforms and one or more networks. The functionality may be distributed in any manner, or may be located in a single computing device (e.g., a server, a client computer, and the like). In such arrangements, any and/or all of the above-discussed communications may correspond to data being accessed, moved, modified, updated, and/or otherwise used by a single computing platform. Additionally or alternatively, the computing platform discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. An unauthorized activity detection computing platform, comprising:
at least a first processor;
a communication interface communicatively coupled to the at least a first processor; and
a memory storing computer-readable instructions that, when executed by the at least a first processor, cause the unauthorized activity detection computing platform to:
receive an indication of an unauthorized activity event;
identify a user associated with the unauthorized activity event;
identify, for a first evaluation time period, a plurality of merchants at which the user generated a record;
retrieve, from a database storing record information, authorization and claim data for the plurality of merchants for the first evaluation time period, the claim data including data related to unauthorized activity events;
determine whether a number of unauthorized activity events in the claim data received for a first merchant for the first evaluation time period is above a first threshold;
responsive to determining that the number of unauthorized activity events for the first merchant for the first evaluation time period is not above a first threshold, determine whether additional merchants are available for evaluation;
responsive to determining that the number of unauthorized activity events for the first merchant for the first evaluation time period is at or above the first threshold, retrieve additional authorization and claims data for the first merchant for a second evaluation time period;
analyze the authorization and claims data from the second evaluation time period to identify a control limit for the first merchant;
determine whether the number of unauthorized activity events in the first evaluation time period for the first merchant is above the control limit for the first merchant;
responsive to determining that the number of unauthorized activity events in the first evaluation time period for the first merchant is not above the control limit for the first merchant, remove the first merchant from further processing; and
responsive to determining that the number of unauthorized activity events in the first evaluation time period for the first merchant is at or above the control limit for the first merchant, generate a priority score for the first merchant, the priority score indicating a priority for further evaluating the first merchant with respect to unauthorized activity.

2. The unauthorized activity detection computing platform of claim 1, further including instructions that, when executed, cause the unauthorized activity detection computing platform to:
responsive to determining that the number of unauthorized activity events in the first evaluation time period for the first merchant is at or above the control limit, and prior to generating a priority score for the first merchant, evaluate the first merchant to determine whether the first merchant meets one or more exclusion rules.

3. The unauthorized activity detection computing platform of claim 2, further including instructions that, when executed, cause the unauthorized activity detection computing platform to:
responsive to determining that the first merchant meets one or more exclusion rules, exclude the first merchant from further analysis; and
responsive to determining that the first merchant does not meet one or more exclusion rules, generate the priority score for the first merchant.

4. The unauthorized activity detection computing platform of claim 1, wherein the control limit for the first merchant includes an expected number of unauthorized activity events for a predefined time period.

5. The unauthorized activity detection computing platform of claim 1, further including instructions that, when executed, cause the unauthorized activity detection computing platform to:
identify a category associated with the first merchant;
retrieve, from a database storing record information, authorization and claims data for the first merchant and the identified category for the first evaluation time period;
determine whether a number of unauthorized activity events for the first merchant and the identified category is above a second threshold;
responsive to determining that the number of unauthorized activity events for the first evaluation time period for the first merchant and the identified category is not above the second threshold, determine whether additional merchants are available for evaluation;
responsive to determining that the number of unauthorized activity events for the first evaluation time period for the first merchant and the first category is at or above the second threshold, retrieve additional authorization and claim data for the first merchant and the identified category for the second evaluation time period;
analyze the additional authorization and claims data from the second evaluation period to identify a control limit for the first merchant and identified category;
determine whether the number of unauthorized activity events in the first evaluation time period for the first merchant and the identified category is above the control limit for the first merchant and the identified category;
responsive to determining that the number of unauthorized activity events in the first evaluation time period for the first merchant and the identified category is not above the control limit for the first merchant and the identified category, remove the first merchant from further processing; and
responsive to determining that the number of unauthorized activity events in the first evaluation time period for the first merchant and the identified category is at or above the control limit for the first merchant and the identified category, generate a priority score for the first merchant and the identified category, the priority score indicating a priority for further evaluating the first merchant and identified category with respect to unauthorized activity.

6. The unauthorized activity detection computing platform of claim 5, further including instructions that, when executed, cause the unauthorized activity detection computing platform to:
identify a state associated with the first merchant;
retrieve, from a database storing record information, authorization and claims data for the first merchant, the identified category, and the identified state for the first evaluation time period;
determine whether a number of unauthorized activity events for the first evaluation time period for the first merchant, the identified category, and the identified state is above a third threshold;
responsive to determining that the number of unauthorized activity events for the first evaluation time period for the first merchant, the identified category, and the identified state is not above the third threshold, determine whether additional merchants are available for evaluation;
responsive to determining that the number of unauthorized activity events for the first evaluation time period for the first merchant, the first category, and the identified state is at or above the third threshold, retrieve additional authorization and claims data for the first merchant, the identified category, and the identified state for the second evaluation time period;
analyze the additional authorization and claims data from the second evaluation period to identify a control limit for the first merchant, the identified category, and the identified state;
determine whether the number of unauthorized activity events in the first evaluation period for the first merchant, the identified category, and the identified state is above the control limit for the first merchant, the identified category, and the identified state;
responsive to determining that the number of unauthorized activity events in the first evaluation period for the first merchant, the identified category, and the identified state is not above the control limit for the first merchant, the identified category, and the identified state, remove the first merchant from further processing; and
responsive to determining that the number of unauthorized activity events in the first evaluation period for the first merchant, the identified category, and the identified state is at or above the control limit for the first merchant, the identified category, and the identified state, generate a priority score for the first merchant, the identified category and the identified state, the priority score indicating a priority for further evaluating the first merchant, the identified category and the identified state with respect to unauthorized activity.

7. The unauthorized activity detection computing platform of claim 6, further including instructions that, when executed, cause the unauthorized activity detection computing platform to:
identify a city associated with the first merchant;
retrieve, from a database storing record information, authorization and claims data for the first merchant, the identified category, the identified state, and the identified city for the first evaluation time period;
determine whether a number of unauthorized activity events for the first merchant, the identified category, the identified state and the identified city in the first evaluation period is above a fourth threshold;
responsive to determining that the number of unauthorized activity events for the first merchant, the identified category, the identified state, and the identified city for the first evaluation period is not above the fourth threshold, determine whether additional merchants are available for evaluation;
responsive to determining that the number of unauthorized activity events for the first merchant, the first category, the identified state, and the identified city for the first evaluation period is at or above the fourth threshold, retrieve additional authorization and claims data for the first merchant, the identified category, the identified state, and the identified city for the second evaluation time period;
analyze the additional authorization and claims data from the second evaluation period to identify a control limit for the first merchant, the identified category, the identified state, and the identified city;
determine whether the number of unauthorized activity events in the first evaluation period for the first merchant, the identified category, the identified state, and the identified city is above the control limit for the first merchant, the identified category, the identified state, and the identified city;
responsive to determining that the number of unauthorized activity events in the first evaluation period for the first merchant, the identified category, the identified state, and the identified city is not above the control limit for the first merchant, the identified category, the identified state, and the identified city, remove the first merchant from further processing; and
responsive to determining that the number of unauthorized activity events in the first evaluation period for the first merchant, the identified category, the identified state, and the identified city is at or above the control limit for the first merchant, the identified category, the identified state, and the identified city, generate a priority score for the first merchant, the identified category, the identified state, and the identified city, the priority score indicating a priority for further evaluating the first merchant, the identified category, the identified state, and the identified city with respect to unauthorized activity.

8. A method, comprising:
receiving, by an unauthorized activity detection system, an indication of an unauthorized activity event;
identifying, by the unauthorized activity detection system, a user associated with the unauthorized activity event;
identifying, for a first evaluation time period, a plurality of merchants at which the user generated a record;
retrieving, from a database storing record information, authorization and claim data for the plurality of merchants for the first evaluation time period, the claim data including data related to unauthorized activity events;
determining, by the unauthorized activity detection system, whether a number of unauthorized activity events in the claim data received for a first merchant for the first evaluation time period is above a first threshold;
responsive to determining that the number of unauthorized activity events for the first merchant for the first evaluation time period is at or above the first threshold, retrieving, by the unauthorized activity detection system additional authorization and claims data for the first merchant for a second evaluation time period;
analyzing, by the unauthorized activity detection system, the authorization and claims data from the second evaluation time period to identify a control limit for the first merchant;
determining, by the unauthorized activity detection system, whether the number of unauthorized activity events in the first evaluation time period for the first merchant is above the control limit for the first merchant; and
responsive to determining that the number of unauthorized activity events in the first evaluation time period for the first merchant is at or above the control limit for the first merchant, generating, by the unauthorized activity detection system, a priority score for the first merchant, the priority score indicating a priority for further evaluating the first merchant with respect to unauthorized activity.

9. The method of claim 8, further including:
responsive to determining that the number of unauthorized activity events in the first evaluation time period for the first merchant is at or above the control limit, and prior to generating a priority score for the first merchant, evaluating, by the unauthorized activity detection system, the first merchant to determine whether the first merchant meets one or more exclusion rules.

10. The method of claim 9, further including:
responsive to determining that the first merchant meets one or more exclusion rules, excluding, by the unauthorized activity detection system, the first merchant from further analysis.

11. The method of claim 8, wherein the control limit for the first merchant includes an expected number of unauthorized activity events for a predefined time period.

12. The method of claim 8, further including:
identifying, by the unauthorized activity detection system, a category associated with the first merchant;
retrieving, from a database storing record information and by the unauthorized activity detection system, authorization and claims data for the first merchant and the identified category for the first evaluation time period;
determining, by the unauthorized activity detection system, whether a number of unauthorized activity events for the first merchant and the identified category is above a second threshold;
responsive to determining that the number of unauthorized activity events for the first evaluation time period for the first merchant and the first category is at or above the second threshold, retrieving, by the unauthorized activity detection system, additional authorization and claim data for the first merchant and the identified category for the second evaluation time period;
analyzing, by the unauthorized activity detection system, the additional authorization and claims data from the second evaluation period to identify a control limit for the first merchant and identified category;
determining, by the unauthorized activity detection system, whether the number of unauthorized activity events in the first evaluation time period for the first merchant and the identified category is above the control limit for the first merchant and the identified category; and
responsive to determining that the number of unauthorized activity events in the first evaluation time period for the first merchant and the identified category is at or above the control limit for the first merchant and the identified category, generating, by the unauthorized activity detection system, a priority score for the first merchant and the identified category, the priority score indicating a priority for further evaluating the first merchant and identified category with respect to unauthorized activity.

13. The method of claim 12, further including:
Identifying, by the unauthorized activity detection system, a state associated with the first merchant;
retrieving, from a database storing record information and by the unauthorized activity detection system, authorization and claims data for the first merchant, the identified category, and the identified state for the first evaluation time period;
determining, by the unauthorized activity detection system, whether a number of unauthorized activity events for the first evaluation time period for the first merchant, the identified category, and the identified state is above a third threshold;
responsive to determining that the number of unauthorized activity events for the first evaluation time period for the first merchant, the first category, and the identified state is at or above the third threshold, retrieving, by the unauthorized activity detection system, additional authorization and claims data for the first merchant, the identified category, and the identified state for the second evaluation time period;
analyzing, by the unauthorized activity detection system, the additional authorization and claims data from the second evaluation period to identify a control limit for the first merchant, the identified category, and the identified state;
determining, by the unauthorized activity detection system, whether the number of unauthorized activity events in the first evaluation period for the first merchant, the identified category, and the identified state is above the control limit for the first merchant, the identified category, and the identified state; and
responsive to determining that the number of unauthorized activity events in the first evaluation period for the first merchant, the identified category, and the identified state is at or above the control limit for the first merchant, the identified category, and the identified state, generating, by the unauthorized activity detection system, a priority score for the first merchant, the identified category and the identified state, the priority score indicating a priority for further evaluating the first merchant, the identified category and the identified state with respect to unauthorized activity.

14. The method of claim 13, further including:
identifying, by the unauthorized activity detection system, a city associated with the first merchant;
retrieving, from a database storing record information and by the unauthorized activity detection system, authorization and claims data for the first merchant, the identified category, the identified state, and the identified city for the first evaluation time period;
determining, by the unauthorized activity detection system, whether a number of unauthorized activity events for the first merchant, the identified category, the identified state and the identified city in the first evaluation period is above a fourth threshold;
responsive to determining that the number of unauthorized activity events for the first merchant, the first category, the identified state, and the identified city for the first evaluation period is at or above the fourth threshold, retrieving, by the unauthorized activity detection system, additional authorization and claims data for the first merchant, the identified category, the identified state, and the identified city for the second evaluation time period;
analyzing, by the unauthorized activity detection system, the additional authorization and claims data from the second evaluation period to identify a control limit for the first merchant, the identified category, the identified state, and the identified city;
determining, by the unauthorized activity detection system, whether the number of unauthorized activity events in the first evaluation period for the first merchant, the identified category, the identified state, and the identified city is above the control limit for the first merchant, the identified category, the identified state, and the identified city; and
responsive to determining that the number of unauthorized activity events in the first evaluation period for the first merchant, the identified category, the identified state, and the identified city is at or above the control limit for the first merchant, the identified category, the identified state, and the identified city, generating, by the unauthorized activity detection system, a priority score for the first merchant, the identified category, the identified state, and the identified city, the priority score indicating a priority for further evaluating the first merchant, the identified category, the identified state, and the identified city with respect to unauthorized activity.

15. One or more non-transitory computer-readable media storing instructions that, when executed by a computer system comprising at least one processor, memory, and a communication interface, cause the computer system to:
receive an indication of an unauthorized activity event;
identify a user associated with the unauthorized activity event;
identify, for a first evaluation time period, a plurality of merchants at which the user generated a record;
retrieve, from a database storing record information, authorization and claim data for the plurality of merchants for the first evaluation time period, the claim data including data related to unauthorized activity events;
determine whether a number of unauthorized activity events in the claim data received for a first merchant for the first evaluation time period is above a first threshold;
responsive to determining that the number of unauthorized activity events for the first merchant for the first evaluation time period is not above a first threshold, determine whether additional merchants are available for evaluation;
responsive to determining that the number of unauthorized activity events for the first merchant for the first evaluation time period is at or above the first threshold, retrieve additional authorization and claims data for the first merchant for a second evaluation time period;
analyze the authorization and claims data from the second evaluation time period to identify a control limit for the first merchant;
determine whether the number of unauthorized activity events in the first evaluation time period for the first merchant is above the control limit for the first merchant;
responsive to determining that the number of unauthorized activity events in the first evaluation time period for the first merchant is not above the control limit for the first merchant, remove the first merchant from further processing; and
responsive to determining that the number of unauthorized activity events in the first evaluation time period for the first merchant is at or above the control limit for the first merchant, generate a priority score for the first merchant, the priority score indicating a priority for further evaluating the first merchant with respect to unauthorized activity.

16. The one or more non-transitory computer-readable media of claim 15, further including instructions that, when executed, cause the computing system to:
responsive to determining that the number of unauthorized activity events in the first evaluation time period for the first merchant is at or above the control limit, and prior to generating a priority score for the first merchant, evaluate the first merchant to determine whether the first merchant meets one or more exclusion rules.

17. The one or more non-transitory computer-readable media of claim 16, further including instructions that, when executed, cause the computing system to:
responsive to determining that the first merchant meets one or more exclusion rules, exclude the first merchant from further analysis; and
responsive to determining that the first merchant does not meet one or more exclusion rules, generate the priority score for the first merchant.

18. The one or more non-transitory computer-readable media of claim 15, further including instructions that, when executed, cause the computing system to:
identify a category associated with the first merchant;
retrieve, from a database storing record information, authorization and claims data for the first merchant and the identified category for the first evaluation time period;
determine whether a number of unauthorized activity events for the first merchant and the identified category is above a second threshold;
responsive to determining that the number of unauthorized activity events for the first evaluation time period for the first merchant and the identified category is not above the second threshold, determine whether additional merchants are available for evaluation;
responsive to determining that the number of unauthorized activity events for the first evaluation time period for the first merchant and the first category is at or above the second threshold, retrieve additional authorization and claim data for the first merchant and the identified category for the second evaluation time period;
analyze the additional authorization and claims data from the second evaluation period to identify a control limit for the first merchant and identified category;
determine whether the number of unauthorized activity events in the first evaluation time period for the first merchant and the identified category is above the control limit for the first merchant and the identified category;
responsive to determining that the number of unauthorized activity events in the first evaluation time period for the first merchant and the identified category is not above the control limit for the first merchant and the identified category, remove the first merchant from further processing; and
responsive to determining that the number of unauthorized activity events in the first evaluation time period for the first merchant and the identified category is at or above the control limit for the first merchant and the identified category, generate a priority score for the first merchant and the identified category, the priority score indicating a priority for further evaluating the first merchant and identified category with respect to unauthorized activity.

19. The one or more non-transitory computer-readable media of claim 18, further including instructions that, when executed, cause the computing system to:
identify a state associated with the first merchant;
retrieve, from a database storing record information, authorization and claims data for the first merchant, the identified category, and the identified state for the first evaluation time period;
determine whether a number of unauthorized activity events for the first evaluation time period for the first merchant, the identified category, and the identified state is above a third threshold;
responsive to determining that the number of unauthorized activity events for the first evaluation time period for the first merchant, the identified category, and the identified state is not above the third threshold, determine whether additional merchants are available for evaluation;
responsive to determining that the number of unauthorized activity events for the first evaluation time period for the first merchant, the first category, and the identified state is at or above the third threshold, retrieve additional authorization and claims data for the first merchant, the identified category, and the identified state for the second evaluation time period;
analyze the additional authorization and claims data from the second evaluation period to identify a control limit for the first merchant, the identified category, and the identified state;
determine whether the number of unauthorized activity events in the first evaluation period for the first merchant, the identified category, and the identified state is above the control limit for the first merchant, the identified category, and the identified state;
responsive to determining that the number of unauthorized activity events in the first evaluation period for the first merchant, the identified category, and the identified state is not above the control limit for the first merchant, the identified category, and the identified state, remove the first merchant from further processing; and
responsive to determining that the number of unauthorized activity events in the first evaluation period for the first merchant, the identified category, and the identified state is at or above the control limit for the first merchant, the identified category, and the identified state, generate a priority score for the first merchant, the identified category and the identified state, the priority score indicating a priority for further evaluating the first merchant, the identified category and the identified state with respect to unauthorized activity.

20. The one or more non-transitory computer-readable media of claim 19, further including instructions that, when executed, cause the computing system to:
identify a city associated with the first merchant;
retrieve, from a database storing record information, authorization and claims data for the first merchant, the identified category, the identified state, and the identified city for the first evaluation time period;
determine whether a number of unauthorized activity events for the first merchant, the identified category, the identified state and the identified city in the first evaluation period is above a fourth threshold;
responsive to determining that the number of unauthorized activity events for the first merchant, the identified category, the identified state, and the identified city for the first evaluation period is not above the fourth threshold, determine whether additional merchants are available for evaluation;
responsive to determining that the number of unauthorized activity events for the first merchant, the first category, the identified state, and the identified city for the first evaluation period is at or above the fourth threshold, retrieve additional authorization and claims data for the first merchant, the identified category, the identified state, and the identified city for the second evaluation time period;
analyze the additional authorization and claims data from the second evaluation period to identify a control limit for the first merchant, the identified category, the identified state, and the identified city;
determine whether the number of unauthorized activity events in the first evaluation period for the first merchant, the identified category, the identified state, and the identified city is above the control limit for the first merchant, the identified category, the identified state, and the identified city;
responsive to determining that the number of unauthorized activity events in the first evaluation period for the first merchant, the identified category, the identified state, and the identified city is not above the control limit for the first merchant, the identified category, the identified state, and the identified city, remove the first merchant from further processing; and
responsive to determining that the number of unauthorized activity events in the first evaluation period for the first merchant, the identified category, the identified state, and the identified city is at or above the control limit for the first merchant, the identified category, the identified state, and the identified city, generate a priority score for the first merchant, the identified category, the identified state, and the identified city, the priority score indicating a priority for further evaluating the first merchant, the identified category, the identified state, and the identified city with respect to unauthorized activity.
